(19) United States
(12) Patent Application Publication
(10) Pub. No.: US 2021/0133787 A1
(43) Pub. Date: May 6, 2021

(54) SYSTEM AND METHOD FOR PRODUCT POPULARITY ANALYSIS AND MANAGEMENT

(71) Applicant: Home Intelligence Co., Ltd., Taipei City (TW)

(72) Inventors: Chun-Nan CHEN, Taipei City (TW); Ivy H. TSENG, Taipei City (TW); Yen-Cheng LIN, Taipei City (TW)

(73) Assignee: Home Intelligence Co., Ltd., Taipei City (TW)

(21) Appl. No.: 16/673,002

(22) Filed: Nov. 4, 2019

(51) Int. Cl. G06Q 30/02; G06K 9/00

(52) U.S. Cl. CPC G06Q 30/0205; G06K 19/06037; G06K 9/00718; G06K 9/00778

(57) ABSTRACT

A system for product popularity analysis and management, applied to a store with products, includes a monitor device capturing an image or a video of the store interior; a product positioning device obtaining location data indicating locations of the corresponding visual symbols by analyzing the image, and retrieving information data of the products by scanning the visual symbols in the image; a hot-zone analyzing device detecting and recording traffic flows of customers in the store according to the video, generating plural hot-zone data associated with activities of the customers at locations in the store by analyzing the traffic flows of the customers; and a processing device defining cover regions based on the locations of the corresponding visual symbols, integrating the hot-zone data falling into a common cover region, and pairing the integrated hot-zone data with the information data of the corresponding visual symbol associated with the common cover region.

### FIELD OF THE PRESENT INVENTION

The present invention relates to a product analysis system, and especially to a system and method for product popularity analysis and management.

### DESCRIPTION OF THE RELATED ART

Most retail stores currently have monitor devices such as cameras that may be used to capture a customer's body shape, trace the customer's body characteristics, analyze the customer's stay-time at each location, and also to determine the popularity of each product in accordance with an analysis of the customer's stay-time at each location and the location information of each product. Another method of analyzing the popularity of each product in a store is to analyze traffic flows via heat-sensing devices only to confirm the number of people who have been in front of certain products (or categories) for a while, so as to know which products (or categories) are popular with customers.

However, the location of each product (or category) in the store may change. If the location information of each product needs to be updated or re-entered manually every time the location information changes, it is too time-consuming and labor-intensive.

### BRIEF SUMMARY OF THE PRESENT INVENTION

In order to resolve the issue described above, the present invention discloses a system for product popularity analysis and management, applied to a store with a plurality of products, wherein each product has a corresponding visual symbol having information of the corresponding product, the corresponding visual symbol is arranged around or near the corresponding product. The system for product popularity analysis and management comprises: a monitor device, a product positioning device, a hot-zone analyzing device, and a processing device. The monitor device is configured to capture an image or a video in the store. The product positioning device is configured to obtain location data indicating locations of the corresponding visual symbols by analyzing the image and to retrieve information data about the plurality of products by scanning the visual symbols in the image. The hot-zone analyzing device is configured to detect and record traffic flows of customers in the store in accordance with the video, and to generate a plurality of hot-zone data associated with activities of the customers at locations in the store by analyzing the traffic flows of the customers. The processing device is configured to define cover regions based on the locations of the corresponding visual symbols, integrate the hot-zone data falling into a common cover region, and pair the integrated hot-zone data with the information data of the corresponding visual symbol associated with the common cover region.

According to the system for product popularity analysis and management disclosed above, the hot-zone data associated with the activities of the customers comprises data of the stay-time of the customers, data of the number of stays of the customers, data of the number of passing of the customers, data of the main traffic flows of the customers, and data of motion trail of the customers.

According to the system for product popularity analysis and management disclosed above, the corresponding visual symbol is a Quick Response Code (QR code), a two-dimensional code, an optical readable code, or a machine readable binary code.

According to the system for product popularity analysis and management disclosed above, the information data of the plurality of products at least comprises the product IDs of the plurality of products.

According to the system for product popularity analysis and management disclosed above, the product positioning device is further configured to compare the image with a previous image captured by the monitor device and to determine to update location data of the visual symbols in the store when detecting that any of the visual symbols has been moved from its original location to another location.

The present invention discloses a method for product popularity analysis and management, applied to a store with a plurality of products, wherein each product has a corresponding visual symbol having information about the corresponding product and the corresponding visual symbol is arranged around or near the corresponding product. The method for product popularity analysis and management comprises: capturing an image or a video in the store using a monitor device; obtaining location data indicating locations of the corresponding visual symbols by analyzing the image using a first processor; retrieving information data of the plurality of products by scanning the visual symbols in the image using the first processor; detecting and recording traffic flows of customers in the store in accordance with the video using a second processor; generating a plurality of hot-zone data associated with activities of the customers at locations in the store by analyzing the traffic flows of the customers in the store using the second processor; defining cover regions based on the locations of the corresponding visual symbols using a processing device; integrating the hot-zone data falling into a common cover region, and pairing the integrated hot-zone data with the information data of the corresponding visual symbol associated with the common cover region using the processing device.

According to the method for product popularity analysis and management disclosed above, the hot-zone data associated with the activities of the customers comprises data of the stay-time of the customers, data of the number of stays of the customers, data of the number of passing of the customers, data of the main traffic flows of the customers, and data of motion trail of the customers.

According to the method for product popularity analysis and management disclosed above, the corresponding visual symbol is a Quick Response Code (QR code), a two-dimensional code, an optical readable code, or a machine readable binary code.

According to the method for product popularity analysis and management disclosed above, the information data of the plurality of products at least comprises product IDs of the plurality of products.

According to the method for product popularity analysis and management disclosed above, the first processor is further configured to compare the image with a previous image captured by the monitor device and to determine to update location data of the visual symbols in the store when detecting that any of the visual symbols has been moved from its original location to another location.

### BRIEF DESCRIPTION OF THE DRAWINGS

FIG. 1 is a block diagram of a system 100 for product popularity analysis and management in accordance with an embodiment of the disclosure.

FIG. 2 is a schematic diagram of an operation of the system 100 in accordance with the embodiment of the disclosure.

FIG. 3 is a schematic diagram of cover regions 118-1 and 118-2 in accordance with the embodiment of the disclosure.

FIG. 4 is a flow chart of a method for product popularity analysis and management in accordance with an embodiment of the disclosure.

FIG. 5 is a schematic diagram of the system 100 applied to two different stores for product popularity analysis and management in accordance with another embodiment of the disclosure.

FIG. 6 is a schematic diagram of correlation between different products in accordance with another embodiment of the disclosure.

### DETAILED DESCRIPTION OF THE PRESENT INVENTION

The present invention can be more fully understood by reading the subsequent detailed description with references made to the accompanying figures.

It should be understood that the figures are not drawn to scale in accordance with standard practice in the industry. In fact, it is allowed to arbitrarily enlarge or reduce the size of devices for clear illustration.

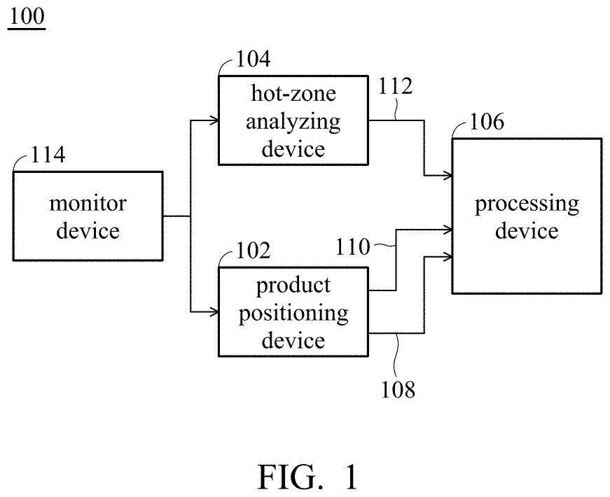

FIG. 1 is a block diagram of a system 100 for product popularity analysis and management in accordance with an embodiment of the disclosure. The system 100 is applied to a store with a plurality of products, wherein each product has a corresponding visual symbol having information about the corresponding product. The corresponding visual symbol is arranged around or near the corresponding product. As shown in FIG. 1, the system 100 comprises a product positioning device 102, a hot-zone analyzing device 104, a processing device 106, and a monitor device 114.

The monitor device 114 is configured to capture an image or a video in the store. The product positioning device 102 is configured to obtain location data 108 indicating locations of the corresponding visual symbols by analyzing the image and to retrieve information data 110 of the plurality of products by scanning the visual symbols in the image. For example, the monitor device 114 can be one or more cameras to capture the image or the video in the store, and the product positioning device 102 includes a central processing unit (CPU), a micro processing unit (MPU), a digital signal processor (DSP), a graphic processing unit (GPU), a micro control unit (MCU), or a tensor processing unit (TPU) running a specific application for product positioning to analyze the image and retrieve information data 110 of the plurality of products by scanning the visual symbols in the image by image processing techniques.

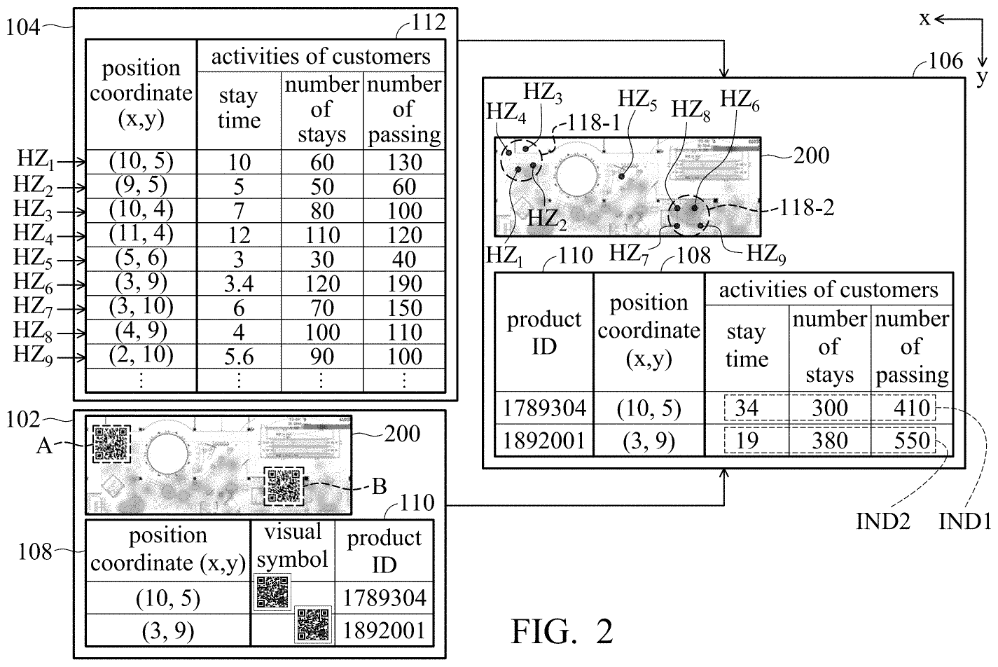

FIG. 2 is a schematic diagram showing operations of the system 100 in accordance with the embodiment of the disclosure. As shown in FIG. 2, for example, the monitor device 114 captures an image 200 in the store, wherein two visual symbols are arranged around or near the corresponding products in the image 200, but is not limited thereto.

The product positioning device 102 obtains the location data 108 indicating locations of the corresponding visual symbols A and B by analyzing the image 200 (in which the visual symbols A and B are captured). For example, the x-y position coordinates (associated with the location data) are (10, 5) for the visual symbol A, and (3, 9) for the visual symbol B. And the product positioning device 102 scans the visual symbols (such as the visual symbol A and the visual symbol B in FIG. 2) in the image 200, and retrieves the information data 110 of the plurality of products by scanning the visual symbols A and B in the image 200. For example, in an embodiment, the visual symbol A corresponds to a product with ID 1789304, and the visual symbol B corresponds to a product with ID 1892001, so that the product positioning device 102 determines that the product with ID 1789304 is located around or near the position coordinates (10, 5), and the product with ID 1892001 is located around or near the position coordinates (3, 9).

In some embodiments, the store may have a plurality of racks where plural products are arranged. For example, the visual symbol A can correspond to a product rack with a first category of products, and the visual symbol B can correspond to another product rack with a second category of products. In some embodiments, the information data 110 includes information such as the product ID, product name, manufacturing date, place of origin, manufacturer, and distributor of each of the products. The visual symbol disclosed in the disclosure is a Quick Response Code (QR code), a two-dimensional code, an optical readable code, or a machine readable binary code, but is not limited thereto. For example, the QR code has black squares arranged in a square grid on a white background, which can be read by a camera and processed by a processor until the image can be appropriately interpreted. The required data is then extracted from patterns that are present in both horizontal and vertical components of the image. In the embodiment, the required data is served as the information data 110.

Refer to FIG. 1 and FIG. 2 at the same time. The hot-zone analyzing device 104 is configured to detect and record traffic flows of customers in the store in accordance with the video (that is, image 200 may be one frame of the video), and to generate a plurality of hot-zone data 112 associated with activities of the customers at customer-reachable locations in the store by analyzing the traffic flows of the customers. For example, in FIG. 2, the customer-reachable locations such as the points HZ₁, HZ₂, HZ₃, HZ₄, HZ₅, HZ₆, HZ₇, HZ₈, HZ₉, . . . etc. in the image 200 are retrieved by the hot-zone analyzing device 104. In each of the points, its corresponding coordinates and the activities of the customers are respectively recorded. Here, the activities of the customers are the stay-time, the number of stays and the number of passing, but are not limited thereto. For example, the hot-zone data 112 associated with the activities of the customers may further comprise the main traffic flows of the customers, and the motion trails of the customers. The number of passing of the customers indicates how many times the customers pass a certain product.

The point HZ₂ is at the position coordinates (9, 5) indicating the hot-zone data 112 with 5 minutes of the stay-time of the customers, 50 times of the number of the stays of the customers, and 60 times of the number of passing of the customers. The point HZ₅ is at the position coordinates (5, 6) indicating the hot-zone data 112 with 3 minutes of the stay-time of the customers, 30 times of the number of stays of the customers, and 40 times of the number of passing of the customers. The point HZ₈ is at the position coordinates (4, 9) indicating the hot-zone data 112 with 4 minutes of the stay-time of the customers, 100 times of the number of stays of the customers, and 110 times of the number of passing of the customers. The points HZ₁, HZ₃, HZ₄, HZ₆, HZ₇, and HZ₉ respectively indicate different corresponding hot-zone data 112 at different position coordinates (x, y) as shown in FIG. 2.

The hot-zone analyzing device 104 can be a server, a workstation, a laptop, a personal computer, or a smartphone with a CPU, an MPU, a DSP, a GPU, an MCU, or a TPU running a specific application for detecting and recording the traffic flows of the customers in the store in accordance with the video from the monitor device 114.

The processing device 106 is configured to define cover regions (118-1 and 118-2) based on the locations of the corresponding visual symbols (A and B), integrate the hot-zone data 112 with position coordinates falling into a common cover region, and pair the integrated hot-zone data with the information data 110 of the corresponding visual symbol associated with the common cover region. For example, in FIG. 2, the processing device 106 can define a cover region 118-1 based on the location of the visual symbol A at the position coordinates (10, 5), and define a cover region 118-2 based on the location of the visual symbol B at the position coordinates (3, 9) in the image 200.

Since the processing device 106 recognizes the points HZ₁, HZ₂, HZ₃, and HZ₄ fall into the cover region 118-1, the processing device 106 integrates the hot-zone data 112 of the points HZ₁, HZ₂, HZ₃, and HZ₄ into the cover region 118-1, and then pairs the integrated hot-zone data of the points HZ₁˜HZ₄ with the information data 110 of the visual symbol A associated with the cover region 118-1. Similarly, since the points HZ₆, HZ₇, HZ₈, and HZ₉ fall into the cover region 118-2, the processing device 106 integrates the hot-zone data 112 of the points HZ₆, HZ₇, HZ₈, and HZ₉ into the cover region 118-2, and pairs the integrated hot-zone data of the points HZ₆˜HZ₉ with the information data 110 of the visual symbol B associated with the cover region 118-2.

For example, the processing device 106 sums the stay time data (10, 5, 7, 12), the number of stays data (60, 50, 80, 110), and the number of passing data (130, 60, 100, 120) in the hot-zone data 112 from the points HZ₁, HZ₂, HZ₃, and HZ₄ to get an integrated hot-zone data (34, 300, 410) indicated as IND1, and then pairs the integrated hot-zone data IND1 with the information data 110 of the visual symbol A associated with the cover region 118-1, so that the processing device 106 determines that the product with ID 1789304 is located at the position coordinates (10, 5), and the stay-time of the customers for the product with ID 1789304 is 34 minutes, the number of stays of customers for the product with ID 1789304 is 300 times, and the number of passing of the customers for the product with ID 1789304 is 410 times.

Similarly, the processing device 106 sums the stay time data, the number of stays data, and the number of passing data in the hot-zone data 112 from the points HZ₆, HZ₇, HZ₈, and HZ₉ to get another integrated hot-zone data (19, 380, 550) indicated as IND2, and pairs the another integrated hot-zone data IND2 with the information data 110 of the visual symbol B associated with the cover region 118-2, so that the processing device 106 also determines that the product with ID 1892001 is located at the position coordinates (3, 9), and the stay-time of the customers for the product with ID 1892001 is 19 minutes, the number of stays of customers for the product with ID 1892001 is 380 times, and the number of passing of the customers for the product with ID 1892001 is 550 times. Therefore, the processing device 106 can determine whether the product with ID 1789304 or the product with ID 1892001 is more popular with the customers in accordance with the integrated hot-zone data IND1 and IND2 having the activities of customers as shown above. The integrated hot-zone data IND1 and IND2 can be calculated by summing or averaging data values of the hot-zone data 112 in the common cover region. For any position coordinate in a store, the stay-time of the customers can be recorded according to the total or the average of the stay-time. In the example of FIG. 2, each of the stay-time of the customers is recorded according to the total stay-time for the corresponding position coordinate. Therefore, the integrated stay-time is calculated by summation. In another example, the stay-time of the customers may be recorded according to the average stay-time for the corresponding position coordinate, and therefore the integrated stay-time can be calculated by averaging.

Generally, for the customers, the longer customer stay-time the cover region has, the more popular the corresponding product is; the higher the number of the customer stays a cover region has, the more popular the corresponding product is; and the higher the number of the customers passing the cover region, the more popular the corresponding product is. The processing device 106 can be a server, a workstation, a laptop, a personal computer, a smartphone, or a similar device with a CPU, an MPU, a DSP, a GPU, an MCU, or a TPU running a specific application for integrating the hot-zone data 112, the location data 108, and the information data 110 to further analyze the popularity of each product.

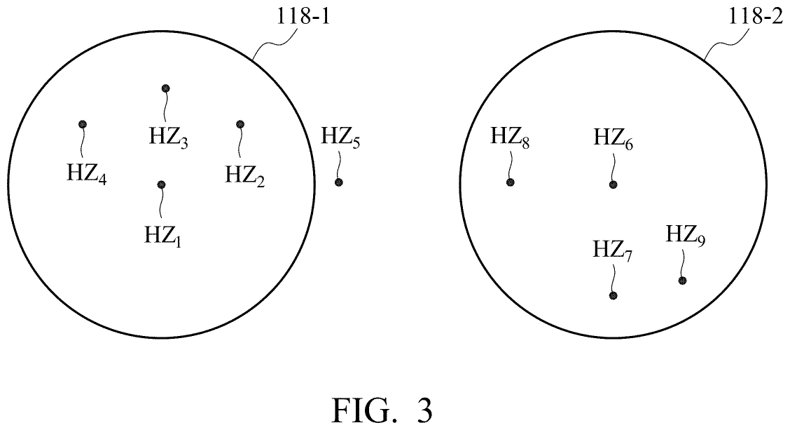

FIG. 3 is a schematic diagram showing the cover regions 118-1 and 118-2 in accordance with the embodiment of the disclosure. It is noted that only the points HZ₁, HZ₂, HZ₃, HZ₄, HZ₅, HZ₆, HZ₇, HZ₈ and HZ₉ are shown in FIG. 3 for example, but in practical application more points can be retrieved for the traffic flow of the customer-reachable locations in the image 200. The shapes of the cover regions 118-1 and 118-2 can be defined such as circle, square, rectangle, polygon and etc. Also, the shapes of the cover regions 118-1 and 118-2 can be defined along the locations of the corresponding products, for example, the cover regions 118-1 and 118-2 may include a plurality of racks where the products are located, or walkways where the customers pass through. In other words, the shapes of the cover regions 118-1 and 118-2 can be defined as any shapes.

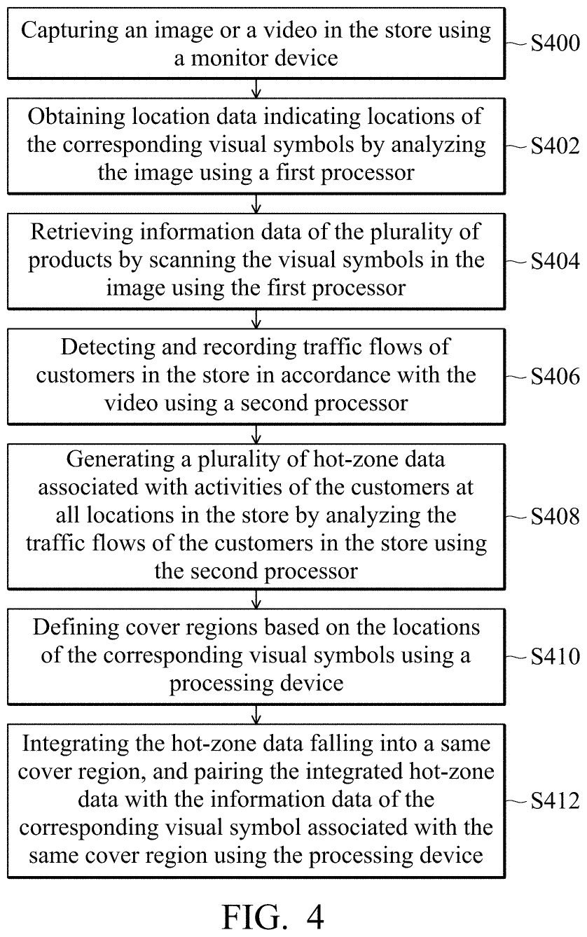

FIG. 4 is a flow chart of a method for product popularity analysis and management in accordance with one embodiment of the disclosure. The method for product popularity analysis and management is applied to a store with a plurality of products, wherein each product has a corresponding visual symbol which has information about the corresponding product and is arranged around or near the corresponding product. The method comprises: capturing an image or a video in the store using a monitor device (S400); obtaining location data indicating locations of the corresponding visual symbols by analyzing the image using a first processor (S402); retrieving information data of the plurality of products by scanning the visual symbols in the image using the first processor (S404); detecting and recording traffic flows of the customers in the store in accordance with the video using a second processor (S406); generating a plurality of hot-zone data associated with activities of the customers at customer-reachable locations in the store by analyzing the traffic flows of the customers in the store using the second processor (S408); defining cover regions based on the locations of the corresponding visual symbols using a processing device (S410), and integrating the hot-zone data falling into a common cover region, and pairing the integrated hot-zone data with the information data of the corresponding visual symbol associated with the common cover region using the processing device (S412). The first processor can be a CPU, an MPU, a DSP, a GPU, an MCU, or a TPU of the product positioning device 102, and the second processor can be a CPU, an MPU, a DSP, a GPU, an MCU, or a TPU of the hot-zone analyzing device 104.

In a store, for example, the locations of products may be rearranged for commercial considerations. Once the locations of the products are rearranged, the corresponding visual symbols of the products are also rearranged. By applying the system and method for product popularity analysis and management, the location data of the rearranged visual symbols can be rapidly updated by the product positioning device 102 without manual operation. In detail, the product positioning device 102 is further configured to compare a present image (after rearranging the products) with a previous image (before rearranging the products), both captured by the monitor device 114, and to determine to update the location data 108 of the visual symbols in the store when detecting that any of the visual symbols has been moved from its original location to another location or disappear. A pairing relationship between the location data 108 of the visual symbols and the information data 110 (especially for product ID) of the rearranged products are updated and stored in the product positioning device 102, for example but is not limited thereto.

For example, initially as shown in FIG. 2, the product with ID 1789304 is first arranged around or near the position coordinates (10, 5) in the image 200, that is, the corresponding visual symbol (the visual symbol A) of the product with ID 1789304 is arranged at the same position. Due to the product with ID 1892001 being sold out, the product with ID 1789304 is moved (rearranged) to around or near the position coordinates (3, 9) where the product with ID 1892001 is originally located around or near, that is, the corresponding visual symbol of the product with ID 1789304 has also been rearranged to the position coordinates (3, 9). After rearranging the product with ID 1789304, the monitor device 114 captures the present image showing that the corresponding visual symbol of the product with ID 1789304 is rearranged to the position coordinates (3, 9), and no visual symbol is arranged at position coordinates (10, 5).

After comparing the present image and the previous image, the product positioning device 102 determines that the product with ID 1789304 is moved to around or near the position coordinates (3, 9), and no visual symbol (no product) is located at the position coordinates (10, 5). Thus, the product positioning device 102 updates the location data 108 of the visual symbol corresponding to the product with ID 1789304 to the position coordinates (3, 9) and erases the location data 108 of the visual symbol corresponding to the product with ID 1892001. Furthermore, the product positioning device 102 pairs the updated location data of the rearranged visual symbol and the information (such as the product ID) of the rearranged product automatically.

For the conventional product management system, once the products and their corresponding visual symbols are rearranged in the store, the location data of the visual symbols and the information of the products must be updated in manual operation. On the contrary, by applying the system and method for product popularity analysis and management of the disclosure, the location data of the rearranged visual symbols can be rapidly updated and automatically paired with the information of the products by the product positioning device 102 without manual operation.

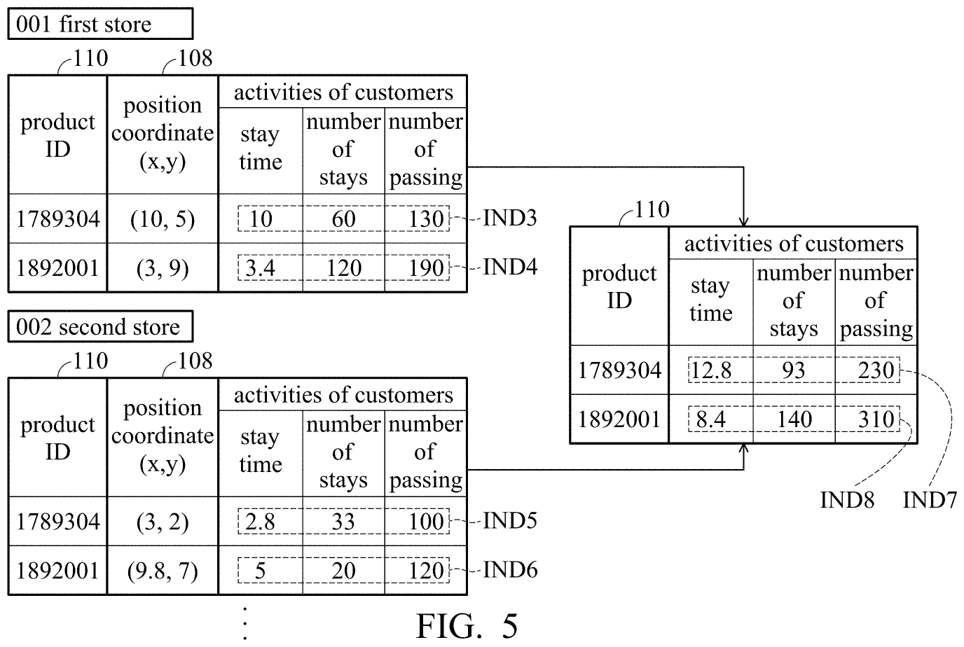

The system or method for product popularity analysis and management of the disclosure can also be applied to two different stores to compare the popularity of different products. FIG. 5 is a schematic diagram of the system 100 applied to two different stores for product popularity analysis and management in accordance with another embodiment of the disclosure. As shown in FIG. 5, the product with ID 1789304 and the product with ID 1892001 are for sale in a first store 001 and a second store 002 at the same time. The visual symbol of the product with ID 1789304 in the first store 001 is arranged at the position coordinates (10, 5) and its integrated hot-zone data (10, 60, 130) indicated as IND3 recording 10 minutes of the stay-time of the customers, 60 times of the number of stays of the customers, and 130 times of the number of passing of the customers. The visual symbol of the product with ID 1892001 in the first store 001 is arranged at the position coordinates (3, 9) and its integrated hot-zone data (3.4, 120, 190) indicated as IND4 recording 3.4 minutes of the stay-time of the customers, 120 times of the number of stays of the customers, and 190 times of the number of passing of the customers.

The visual symbol of the product with ID 1789304 in the second store 002 is arranged at the position coordinates (3, 2) and its integrated hot-zone data (2.8, 33, 100) indicated as IND5 recording 2.8 minutes of the stay-time of the customers, 33 times of the number of stays of the customers, and 100 times of the number of passing of the customers. The visual symbol of the product with ID 1892001 in the second store 002 is arranged at position coordinates (9.8, 7) and its integrated hot-zone data (5, 20, 120) indicated as IND6 recording 5 minutes of the stay-time of the customers, 20 times of the number of stays of the customers, and 120 times of the number of passing of the customers.

The processing device 106 further integrates the integrated hot-zone data IND3 and IND5 of the product with ID 1789304 and integrates the integrated hot-zone data IND4 and IND6 of the product with ID 1892001. For the product with ID 1789304, integrating the integrated hot-zone data IND3 and IND5 obtains the data IND7 as follows: 12.8 minutes of the stay-time of the customers, 93 times of the number of stays of the customers, and 230 times of the number of passing of the customers. For the product with ID 1892001, integrating the integrated hot-zone data IND4 and IND6 obtains the data IND8 as follows: 8.4 minutes of the stay-time of the customers, 140 times of the number of stays of the customers, and 310 times of the number of passing of the customers. Therefore, popularity of the products in the two stores respectively with ID 1789304 and ID 1892001 can be determined in accordance with the data IND7 and IND8 as shown in FIG. 5.

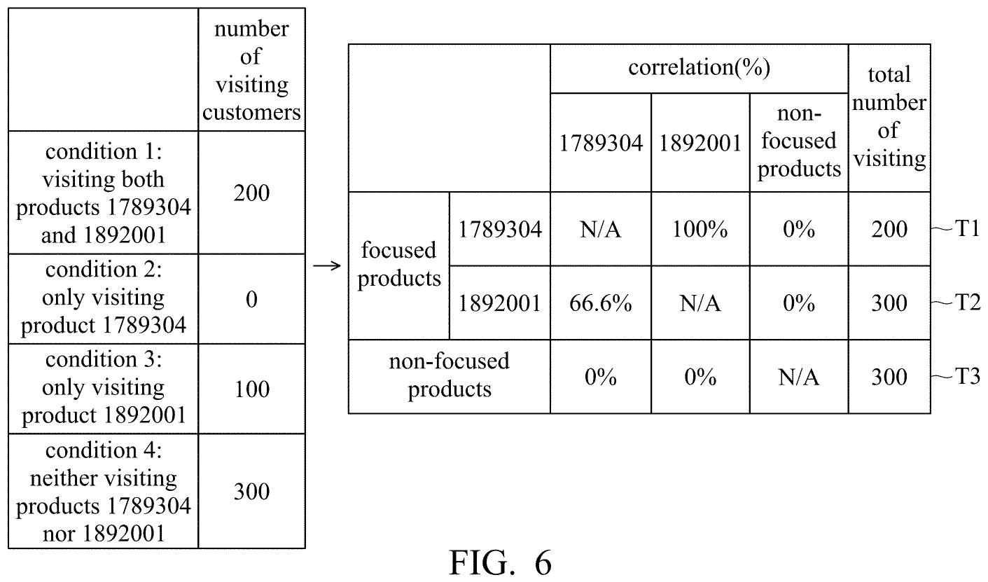

Data of the main traffic flows of the customers and data of the motion trails of the customers in the hot-zone data 112 can be used for calculating a correlation between different products. FIG. 6 is a schematic diagram showing the correlation between different products in accordance with another embodiment of the disclosure. For example, according to FIG. 6, a total of 600 customers visit the first store 001, wherein 200 customers visit both the product with ID 1789304 and the product with ID 1892001 (condition 1), no customer only visits the product with ID 1789304 (condition 2), 100 customers only visit the product with ID 1892001 (condition 3), and 300 customers neither visit the product with ID 1789304 nor the product with ID 1892001 (condition 4), that is, the 300 customers may visit the products in the first store 001 except the two products with ID 1789304 and ID 1892001 respectively. Here, for example only, the two products with ID 1789304 and ID 1892001 respectively are classified as the focused products and the other products in the store 001 are classified as the non-focused products. According to the condition 1 and the condition 2, it can be seen that 200 customers (T1 in FIG. 6) have visited the product with ID 1789304. According to the condition 1 and the condition 3, it can be seen that 300 customers (T2 in FIG. 6) have visited the product with ID 1892001. According to the condition 4, it can be seen that 300 customers (T3 in FIG. 6), neither visiting the product with ID 1789304 nor the product with ID 1892001, can be supposed to have visited the non-focused products.

Among the 300 customers (T2 in FIG. 6) having visited the product with ID 1892001, 200 customers have also visited the product with ID 1789304 in view of the condition 1. The ratio of the visiting number (ID 1789304 to ID 1892001) 200/300=66.6% indicates the correlation between the two products (ID 1789304 and ID 1892001). Among the 200 customers (T1 in FIG. 6) having visited the product with ID 1789304, the 200 customers have also visited the product with ID 1892001 in view of the conditions 1-3. The ratio of the visiting number (ID 1892001 to ID 1789304) 200/200=100% indicates the correlation between the two products (ID 1892001 and ID 1789304). Among the 300 customers (T3 in FIG. 6) having visited the non-focused products, no customer (0 customers) has visited any of the focused products. Therefore, the correlation between the non-focused products and any of the focused products (either with ID 1789304 or ID 1892001) is 0%.

The ordinal in the specification and the claims of the present invention, such as “first”, “second”, “third”, etc., has no sequential relationship, and is just for distinguishing between two different devices with the same name. In the specification of the present invention, the word “couple” refers to any kind of direct or indirect electronic connection. The present invention is disclosed in the preferred embodiments as described above, however, the breadth and scope of the present invention should not be limited by any of the embodiments described above. Persons skilled in the art can make small changes and retouches without departing from the spirit and scope of the invention. The scope of the invention should be defined in accordance with the following claims and their equivalents.

What is claimed is:

1. A system for product popularity analysis and management, applied to a store with a plurality of products, wherein each product has a corresponding visual symbol having information of the corresponding product, the corresponding visual symbol is arranged around or near the corresponding product, the system comprising:
a monitor device, configured to capture an image or a video in the store;
a product positioning device, configured to obtain location data indicating locations of the corresponding visual symbols by analyzing the image and to retrieve information data of the plurality of products by scanning the visual symbols in the image;
a hot-zone analyzing device, configured to detect and record traffic flows of customers in the store in accordance with the video, and to generate a plurality of hot-zone data associated with activities of the customers at locations in the store by analyzing the traffic flows of the customers;
a processing device, configured to define cover regions based on the locations of the corresponding visual symbols, integrate the hot-zone data falling into a common cover region, and pair the integrated hot-zone data with the information data of the corresponding visual symbol associated with the common cover region.

2. The system for product popularity analysis and management as claimed in claim 1, wherein the hot-zone data associated with the activities of the customers comprises data of the stay-time of the customers, data of the number of stays of the customers, data of the number of passing of the customers, data of the main traffic flows of the customers, and data of the motion trail of the customers.

3. The system for product popularity analysis and management as claimed in claim 1, wherein the corresponding visual symbol is a Quick Response Code (QR code), a two-dimensional code, an optical readable code, or a machine readable binary code.

4. The system for product popularity analysis and management as claimed in claim 1, wherein the information data of the plurality of products at least comprises product IDs of the plurality of products.

5. The system for product popularity analysis and management as claimed in claim 1, the product positioning device is further configured to compare the image with a previous image captured by the monitor device and to determine to update location data of the visual symbols in the store when detecting that any of the visual symbols has been moved from its original location to another location.

6. A method for product popularity analysis and management, applied to a store with a plurality of products, wherein each product has a corresponding visual symbol having information of the corresponding product, the corresponding visual symbol is arranged around or near the corresponding product, the method comprising:
capturing an image or a video in the store using a monitor device;
obtaining location data indicating locations of the corresponding visual symbols by analyzing the image using a first processor;
retrieving information data of the plurality of products by scanning the visual symbols in the image using the first processor;
detecting and recording traffic flows of customers in the store in accordance with the video using a second processor;
generating a plurality of hot-zone data associated with activities of the customers at locations in the store by analyzing the traffic flows of the customers in the store using the second processor;
defining cover regions based on the locations of the corresponding visual symbols using a processing device;
integrating the hot-zone data falling into a common cover region, and pairing the integrated hot-zone data with the information data of the corresponding visual symbol associated with the common cover region, by using the processing device.

7. The method for product popularity analysis and management as claimed in claim 6, wherein the hot-zone data associated with the activities of the customers comprises data of the stay-time of the customers, data of the number of stays of the customers, data of the number of passing of the customers, data of the main traffic flows of the customers, and data of the motion trail of the customers.

8. The method for product popularity analysis and management as claimed in claim 6, wherein the corresponding visual symbol is a Quick Response Code (QR code), a two-dimensional code, an optical readable code, or a machine readable binary code.

9. The method for product popularity analysis and management as claimed in claim 6, wherein the information data of the plurality of products at least comprises product IDs of the plurality of products.

10. The method for product popularity analysis and management as claimed in claim 6, wherein the first processor is further configured to compare the image with a previous image captured by the monitor device and to determine to update location data of the visual symbols in the store when detecting that any of the visual symbols has been moved from its original location to another location.
